(19) United States
(12) Patent Application Publication
(10) Pub. No.: US 2009/0045669 A1
(43) Pub. Date: Feb. 19, 2009

(54) Two-Piece Compactor Wheel Tip

(75) Inventors: James D. McPhail, Peoria, IL (US); Michael H. Hinrichsen, Goodfield, IL (US)

Correspondence Address: Caterpillar Inc.;Intellectual Property Dept., AH 9510, 100 N.E. Adams Street, PEORIA, IL, 61629-9510, US

(73) Assignee: Caterpillar Inc.

(21) Appl. No.: 11/844,727

(22) Filed: Aug. 24, 2007

Related U.S. Application Data
(60) Provisional application No. 60/956,676, filed on Aug. 17, 2007.

(51) Int. Cl. E02D 3/026; B23K 31/02; B60B 15/00

(52) U.S. Cl. 301/43; 228/101; 228/262.41

(57) ABSTRACT

A compactor tip assembly for a landfill or soil compactor comprises a base and a tip that are formed from dissimilar materials. The tip may be formed from high carbon steel for wear resistance, while the base may be formed from low carbon steel for easy welding. The compactor tip assembly is attached to the compactor wheel by welding the base to the wheel. The tip and the base each have ground engaging surfaces which may be complementary to one another. A hollow pocket may be formed through the base and in the tip.

This application claims priority to U.S. provisional patent application No. 60/956,676 filed Aug. 17, 2007.

### TECHNICAL FIELD

The field of this invention is tips for landfill and soil compactors.

### BACKGROUND

Landfill compactors are machines which move over landfill deposits to compact the trash. Compacting the trash maximizes the use of the landfill. When the trash is compacted, more material can be disposed in the landfill because it is deposited more densely. Compacting the trash also helps to ensure long term structural stability of the landfill when it is filled and capped with soil. Similarly, soil compactors are machines which move over soil, gravel, or other materials to compact the material in preparation for road construction or other construction purposes.

Landfill compactors and soil compactors typically feature large, heavy steel wheels. The bodies of the machines are also heavy, and the combined weight of the body and the set of wheels on each machine provides the necessary downward force for compaction. To increase the compactive capability, compactor wheels have often been fitted with tips to concentrate the weight force. This is especially common on landfill compactors, where the tips help compact the trash by breaking and grinding it into smaller pieces. The tips are mounted on the cylindrical, ground facing surface of the wheels which is often formed by a wheel wrapper, a relatively thick section of plate steel that is bent around and welded to the wheel hub. The tips extend radially outward from the wheel wrapper in a direction away from the center rotational axis of the wheel.

Several different attachment methods have been used to attach tips to compactor wheels. Welding tips to a compactor wheel is common. Mechanical retention systems have also been employed. For example, U.S. Pat. No. 6,619,883, issued on Sep. 16, 2003, discloses mechanically retaining a landfill compactor tip on a compactor wheel. As another example, U.S. Pat. No. 6,095,717, issued Aug. 1, 2000, discloses a different type of mechanical retention system.

Mechanical retention systems, while permitting easy replacement of the tips after they are worn or damaged, can suffer from several disadvantages. Mechanical retention systems can fail and permit the tip to fall off of the wheel. If the mechanical retention system does not hold the tip tightly to the compactor wheel, such that the tip may move relative to the wheel, the repeated movement of the tip during operation of the compactor can cause the retention system to wear, increasing the frequency of failure. Also, if the tip can move relative to the compactor wheel, it may rattle and create excessive, undesirable noise. If the mechanical retention system does not hold the tip tightly against the wheel, debris such as cables and wire in the trash can become caught in spaces between the tip and the wheel and become tangled around the wheel, causing possible problems for the compactor. Mechanical retention systems can also increase the cost of the compactor. Mechanical retention systems must be designed carefully in order to avoid all of the above disadvantages.

Due in part to the complexity of designing a mechanical retention system for compactor tips, welding tips to compactor wheels is still an attractive option. However, welding also suffers disadvantages. One principal disadvantage has been the difficulty of producing a tip from steel with the most desirable metallurgy, while still permitting a consistent, strong, and durable weld joint to be formed between the tip and the wheel.

Highly durable and wear resistant steels may be desirable in the landfill and soil compacting environment because of the extreme working conditions. These working conditions can sometimes cause the tips to wear too quickly, thus requiring replacement too frequently. Especially in the landfill environment, where moist conditions accompany abrasive materials, tips can sometimes wear too quickly. When a compactor's wheel tips are being serviced, the compactor cannot work, so productivity of the machine declines. Thus, it is desirable to minimize the wear rate of compactor tips, and the resulting frequency of repair and replacement.

However, tips made from highly durable and wear resistant steels, such as high carbon and high alloy steels, are most often not easy to weld. If the compactor wheel is made from a low carbon steel, and if the tip is made from a different, more durable steel such as a medium or high carbon steel, this further complicates the task of welding the tip to the wheel because they are made from dissimilar metals. At the very least, creating a consistent, strong, and durable weld joint between a compactor tip and a compactor wheel made from dissimilar metals requires conditions that are difficult to create in the field where this welding often occurs, and may require skilled, experienced welders.

To avoid the difficulty of welding certain types of steels and of welding dissimilar steels, some manufacturers have avoided using highly durable and wear resistant steels. Rather, these manufacturers have used low carbon steels and relied on heat treating techniques to achieve the necessary hardness in the tip. But the need for heat treating appears to have also led to the tips being designed with a geometry which facilitates such heat treatments, but which is less than optimal for compacting.

In sum, designing compactor tips in the past resulted in trade-offs between material selection for wear resistance and durability, weldability, and tip geometry. Manufacturing techniques have also sometimes been a trade-off, with casting and forging being the primary choices for manufacturing, because some steels are more amenable to casting and/or forging than others.

A new technology for compactor wheel tips is needed which would rebalance these trade-offs, by providing a tip which is both durable and wear resistant, and easily weldable to a compactor wheel.

### SUMMARY

A compactor tip assembly may include a tip formed with a first metal, and a base formed with a second metal dissimilar to the first metal, where the tip and the base are joined together through a weld joint. Each of the tip and the base may have ground engaging surfaces.

A compactor tip assembly may also include a tip and a base, where the tip and the base are joined together through a weld joint, and a hollow pocket is formed at least in the base. Each of the tip and the base may have ground engaging surfaces.

A method of manufacturing a compactor tip assembly may include forming a tip from a medium or high carbon steel, forming a base from a low carbon steel, and preheating at least the tip, and welding the preheated tip to the base.

### BRIEF DESCRIPTION OF THE DRAWINGS

FIGS. 1 and 2 are pictorial views of a compactor tip assembly comprising a tip and a base.

FIGS. 3 and 4 are pictorial views of the tip shown in FIGS. 1 and 2.

FIG. 5 is a pictorial view of the base shown in FIGS. 1 and 2.

FIG. 6 shows a set of compactor tip assemblies from FIGS. 1 and 2 mounted to an exemplary landfill compactor wheel.

FIGS. 7-10 are provided to illustrate the ornamental design of an exemplary, assembled landfill compactor tip assembly.

FIG. 7 is a pictorial view of an exemplary landfill compactor tip assembly.

FIG. 8 is a front view of the exemplary tip shown in FIG. 7. The front and back views are identical.

FIG. 9 is a side view of the exemplary tip shown in FIG. 7. The side views are identical.

FIG. 10 is a top view of exemplary tip shown in FIG. 7. The bottom view is not shown and is not part of the ornamental design.

### DETAILED DESCRIPTION

The following is a detailed description of exemplary embodiments of the invention. The exemplary embodiments described herein and illustrated in the drawing figures are intended to teach the principles of the invention, enabling those of ordinary skill in this art to make and use the invention in many different environments and for many different applications. Therefore, the exemplary embodiments are not intended to be, and should not be considered as a limiting description of the scope of patent protection. Rather, the scope of patent protection shall be defined by the appended claims.

A compactor tip assembly 10 is illustrated in the accompanying drawing figures which is formed in part with highly durable and wear resistant steel, yet still permits a consistent, strong, and durable weld joint to a compactor wheel. The compactor tip assembly 10 is formed by a tip 100 joined to a base 200. The tip 100 may be formed from a steel which is selected to provide desirable wear performance for landfill or soil compacting. The base 200 may be formed from a steel which is selected for excellent weldability characteristics to permit easy welding of the tip assembly 10 to a compactor wheel. The tip 100 and base 200 are separately manufactured, permitting the use of dissimilar materials and processes. The tip 100 and base 200 are then welded together in factory conditions where the quality of the weld between them can be assured. After the tip 100 and base 200 are joined together, the compactor tip assembly 10 is ready for installation. The compactor tip assembly 10 is attached to a compactor wheel by welding the base 100 to the compactor wheel. Because the base 100 can be made from a steel selected for excellent weldability characteristics, the weld between the tip assembly 10 and the compactor wheel can be consistent, strong, and durable, can be made more easily in field conditions, and can be made by relatively less skilled welders.

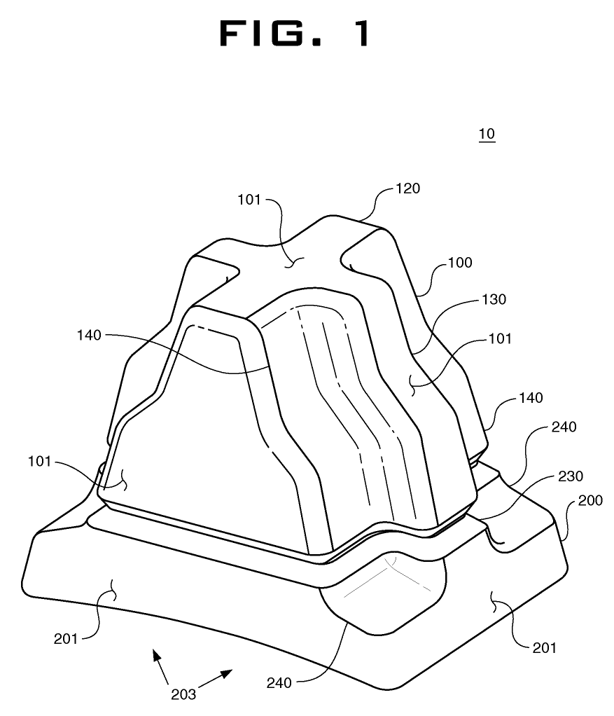

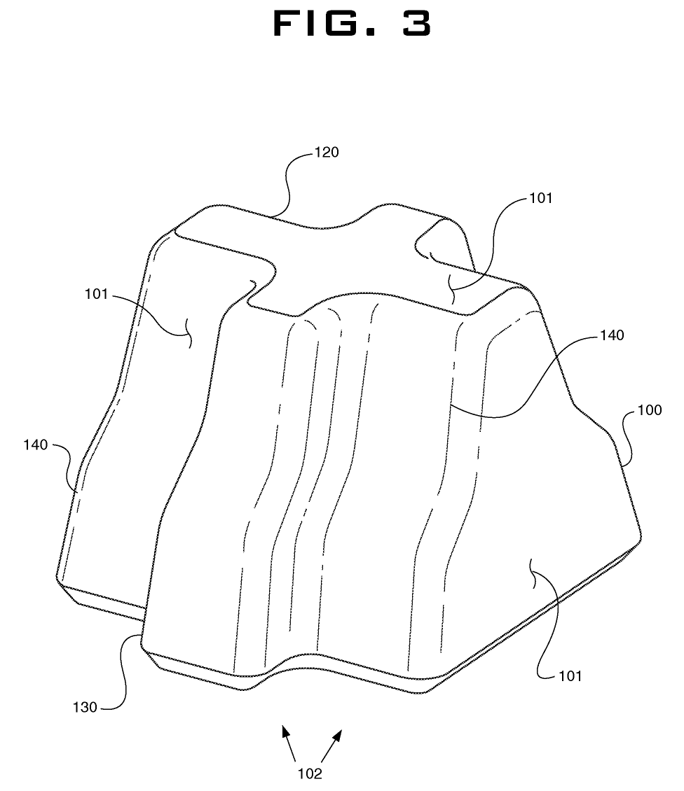

The exterior surfaces of the tip 100 comprise ground engaging surfaces 101, and a base engaging surface 102. The ground engaging surfaces 101 are those surfaces which contact the soil or landfill material during use of the tip 100 when it is attached to base 200 to form the compactor tip assembly 10. All of the exterior surfaces of tip 100 which are visible in FIGS. 1 and 3 are ground engaging surfaces 101, and similar surfaces on the opposite sides of those surfaces which are visible in FIGS. 1 and 3 are also ground engaging surfaces 101. Ground engaging surfaces 101 may be formed to provide appropriate compacting, tearing, and shredding action when the tip 100 engages landfill material or soil. The ground engaging surfaces 101 shown in the accompanying figures are specially designed for landfill compacting, and will be described more fully hereinafter.

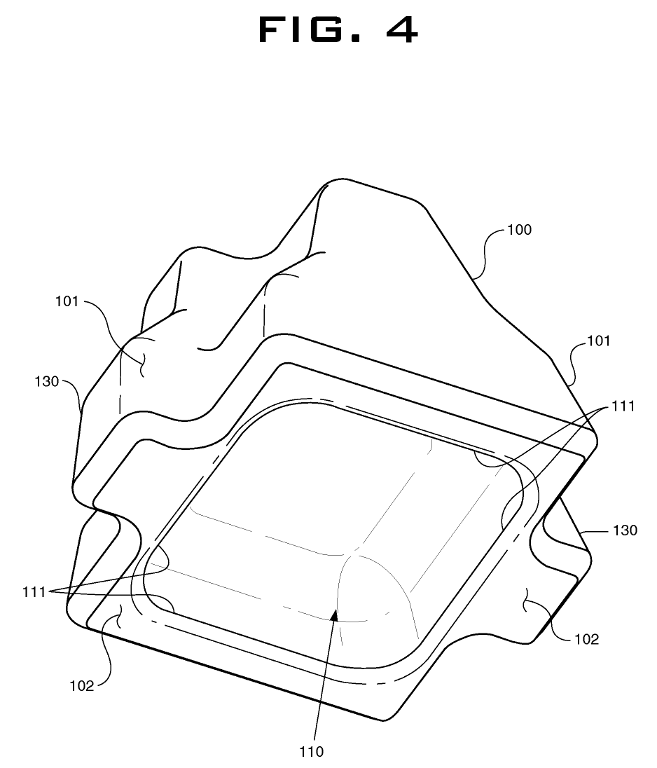

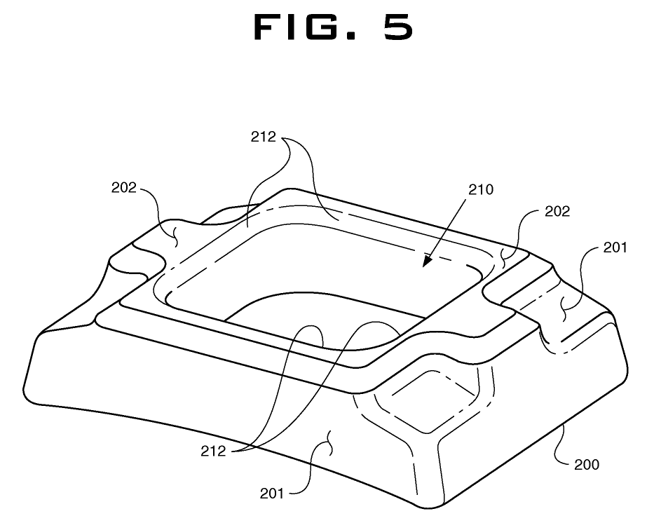

Base engaging surface 102 is the surface of tip 100 which faces, and a portion of which contacts base 200. Base engaging surface 102 can be seen in FIG. 4. A portion of base engaging surface 102 will be in contact with base 200, but because of the manufacturing processes used to produce these parts the surfaces may not align exactly, so that continuous contact with base 200 along the entirety of base engaging surface 102 is not be possible, nor necessary.

The exterior surfaces of base 200 comprise ground engaging surfaces 201 and a tip engaging surface 202. The ground engaging surfaces 201 are those surfaces which contact the soil or landfill material during use of the base 200 when it is attached to tip 100 to form the compactor tip assembly 10. All of the exterior surfaces of base 200 which are visible in FIG. 1 are ground engaging surfaces 201, and similar surfaces on the opposite sides of those surfaces which are visible in FIG. 1 are also ground engaging surfaces 201. Ground engaging surfaces 201 may be formed to provide appropriate compacting, tearing, and shredding action when the base 200 engages landfill material or soil. The ground engaging surfaces 201 shown in the accompanying figures are specially designed for landfill compacting, and will be described more fully hereinafter. Also, the ground engaging surfaces 201 of base 200 may be formed so that they complement the ground engaging surfaces 101 of tip 100.

The tip engaging surface 202 is formed on the base 200 for facing and contacting the base engaging surface 102 of tip 100.

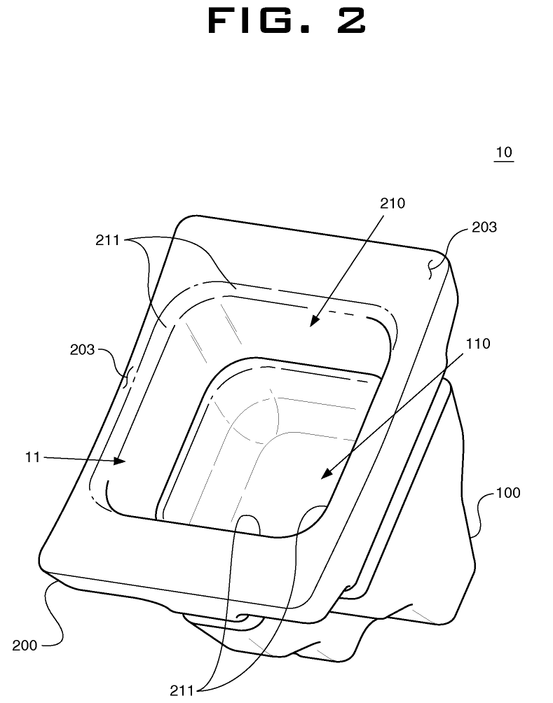

The exterior surfaces of base 200 further comprise a wheel engaging surface 203. Wheel engaging surface 203 is formed generally opposite the tip engaging surface 202, with ground engaging surfaces 201 typically separating the two surfaces. Wheel engaging surface 203 is the surface of base 200 which faces, and a portion of which contacts a compactor wheel. Wheel engaging surface 203 can be best seen in FIG. 2. A portion of wheel engaging surface 203 will be in contact with the compactor wheel when the compactor tip assembly 10 is installed thereon, but because of the manufacturing processes used to produce these parts the surfaces may not align exactly, so that continuous contact with the compactor wheel along the entirety of wheel engaging surface 203 is not be possible, nor necessary. It may be advantageous for wheel engaging surface 203 to be curved to match the circumferential profile of the compactor wheel, as seen in FIGS. 1 and 2.

For the material used to form the tip 100, those of ordinary skill in this art will understand that any particular material may be selected which is appropriate for the working environment of tip 100, the desired manufacturing method (e.g. casting or forging), and other factors. Importantly, the selection of the material for the tip 100 may be based more fully upon “end performance” factors, rather than upon the weldability factor. Even if the material selected for the tip 100 would result in difficulty in joining the tip 100 to the base 200, this difficulty can be managed through the provision of factory controlled conditions which facilitate repeatable and highly precise joining operations.

For the material used to form the base 200, those of ordinary skill in this art will understand that any particular material may be selected which is appropriate for joining to a compactor wheel. Importantly, the selection of the material for the base 200 may be based more fully upon whether the material will permit easy joining, rather than upon whether the material will hold up to the harsh environment experienced by the tip 100 in landfill or soil compacting.

In one embodiment, the tip 100 may be formed of a medium carbon (0.2% to 0.5% by weight) or high carbon (0.5% and more by weight) steel with excellent strength and wear properties. Preferably, the tip 100 is formed from a medium or high carbon, low alloy (less than 8% alloying agents by weight) steel because a higher alloy content could make the joining of the tip 100 to the base 200 more difficult without an appreciable improvement in performance. The shape of tip 100 in the illustrated embodiment permits forging, and forging the tip 100 would result in an additional improvement in its wear properties. The base 200 may be formed from a low carbon (0.2% and less by weight) steel with excellent weldability properties. Preferably, the base 200 is formed from a low carbon, low alloy (less than 8% alloying agents by weight) steel because a higher alloy content could make the joining of the tip 100 to the base 200 more difficult without an appreciable improvement in performance. The shape of base 200 in the illustrated embodiment likewise permits forging, and forging the base 200 would result in an improvement in its wear properties. The tip 100 and base 200 may be joined to one another by welding. The welding process would advantageously occur in factory conditions where the conditions can be precisely controlled and repeated for a consistent, durable, and strong weld joint. Welding a medium or high carbon, low alloy, high strength steel tip 100 to a low carbon steel base 200 preferably will include preheating. In one embodiment, both the base engaging surface 102 and the tip engaging surface 202 are preheated to a temperature of between 150° C. and 230° C. before welding. Preheating is possible when joining the components of compactor tip assembly 10 because each of the tip 100 and base 200 are relatively small pieces which can be manipulated and heated in a furnace or in some other manner with basic equipment.

One advantage of dividing tip assembly 10 into two components, a tip 100 and base 200, is an improvement in manufacturability. A comparable single-piece tip, of comparable size and weight to the compactor tip assembly 10, could be more difficult to manufacture than the smaller, separate components comprising the tip assembly 10. The tip 100 and bore 200 may be a size that will permit them to be cost effectively manufactured by forging. A single-piece tip comparable to the size of compactor tip assembly 10 would be more expensive to forge because the larger the blank to be forged into a part, the larger the equipment needed and the higher the cost. Also, tip 100 and base 200 are lighter and smaller components, which are easier to transport and manipulate during manufacturing compared to a single-piece tip of comparable size.

Another advantage of dividing compactor tip assembly 10 into two components, a tip 100 and base 200, is an improved ability to offer different sizes and styles of a compactor tip assembly 10 while minimizing manufacturing costs. A single size and style of base 200 could be manufactured, to accompany multiple sizes and/or styles of tip 100. The single size and style of base 200 could be combined with different sizes and styles of tip 100 to form different sizes and styles of a compactor tip assembly 10. This would allow multiple styles or sizes of compactor tip assembly 10 to be produced without needing to manufacture and stock separate sizes and types of base 200.

Inclusion of an optional hollow pocket 11 in compactor tip assembly 10 assists in the reduction of weight. Hollow pocket 11 can be best seen in the illustrated embodiment in FIG. 2, and comprises a through passageway 210 in base 200 and a depression 110 formed in tip 100. Hollow pocket 11 need not be formed in the same way, nor take the same shape as it does in the illustrated embodiment. The depression 110 intersects the exterior surface of tip 100 through the base engaging surface 102. In the illustrated embodiment, where the depression 110 intersects the exterior surface of tip 100, an intersection boundary 111 is defined, and the intersection boundary 111 is surrounded around its entire periphery by the base engaging surface 102. The depression 110 extends upwards into the tip 100 from the base engaging surface 102. The through passageway 210 of base 200 extends between, and intersects each of the wheel engaging surface 203 and the tip engaging surface 202. In the illustrated embodiment, where the through passageway 210 interests the wheel engaging surface 203 an intersection boundary 211 is defined, and the intersection boundary 211 is surrounded around its entire periphery by the wheel engaging surface 203. Likewise, in the illustrated embodiment, where the through passageway 210 interests the tip engaging surface 202 an intersection boundary 212 is defined, and the intersection boundary 212 is surrounded around its entire periphery by the wheel engaging surface 202.

The through passageway 210 and the depression 110 may be substantially aligned with one another to form a continuous pocket 11 in the compactor tip assembly 10. The intersection boundaries 212 and 111 could be substantially the same size and shape, so the surfaces of the through passageway 210 and the depression 110 smoothly flow into one another. With this arrangement, an optional secondary weld joint could be formed in the pocket 11 between the tip 100 and base 200, adjacent the intersection boundaries 212 and 111.

In the illustrated embodiment, both the tip 100 and the base 200 include ground engaging surfaces 101 and 201, respectively. However, it would be possible to form tip 100 and base 200 so that the ground engaging surfaces were formed solely on tip 100, and base 200 had no ground engaging surfaces.

In the illustrated embodiment, ground engaging surfaces 101 and 201 are complementary. What is meant by complementary in this instance is that the ground engaging surfaces 101 and 201 functionally work together, or are substantially congruous and flow smoothly into one another. Ground engaging surfaces 101 may include a “plus”-shaped head 120 (i.e. two rectangles overlapping one another at their centers and oriented at ninety degrees relative to one another). The plus-shaped head 120 extends downwards toward the base to form on one side of tip 100 a raised blade 130 surrounded on either side by, and defined by two channels 140. Likewise, the blade 130 is substantially congruous with and flows smoothly into a blade 230 formed in base 200, and channels 140 are substantially congruous with and flow smoothly into channels 240 formed in base 200. Blade 230 and channels 240 are formed in the ground engaging surfaces 201 of base 200. The channels 240 surround and at least partially define blade 230. Blade 230 is a continuation of the shape of blade 130, and blades 130 and 230 are in alignment with one another so that when a weld seam is formed between the tip 100 and base 200, the blades 130 and 230 may appear as a single blade. Likewise, channels 240 are a continuation of the shape of channels 140, and channels 140 and 240 are in alignment with one another so that when a weld seam is formed between the tip 100 and base 200, the channels 140 and 240 may appear as single channels.

The structure discussed above for the ground engaging surfaces 101 and 201 is adapted for a landfill compactor tip. A soil compactor tip assembly would use different structures on the ground engaging surfaces 101 and 201, as will be understood by those of ordinary skill in this art. Nevertheless, the ground engaging surfaces 101 and 201 on a soil compactor tip assembly could still include complementary structures that continue between the tip 100 and base 200 and flow smoothly into one another.

### INDUSTRIAL APPLICABILITY

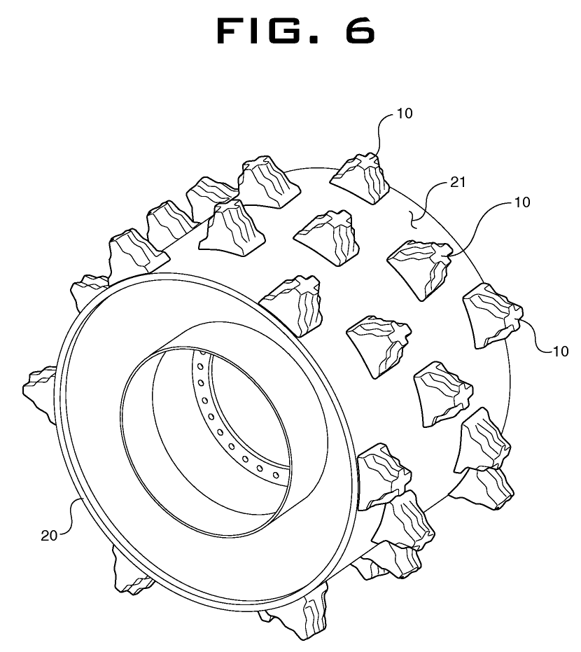

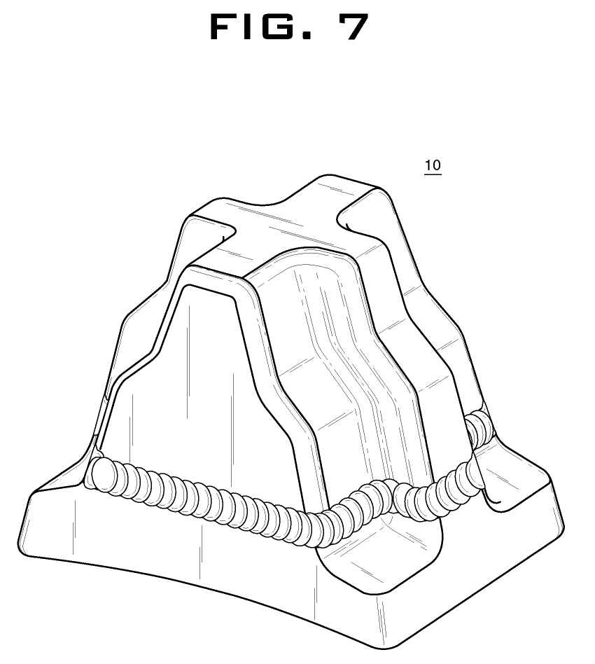

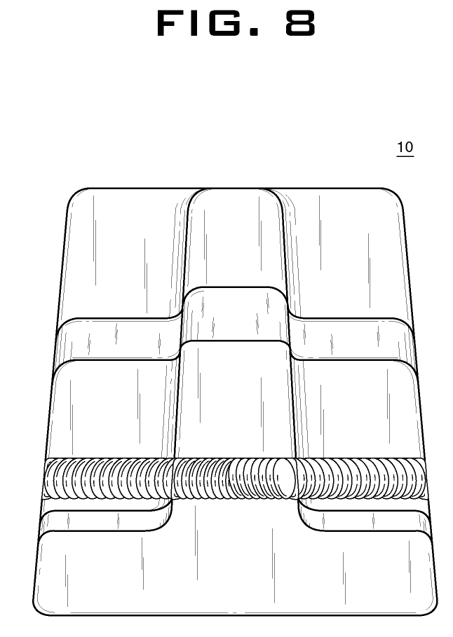

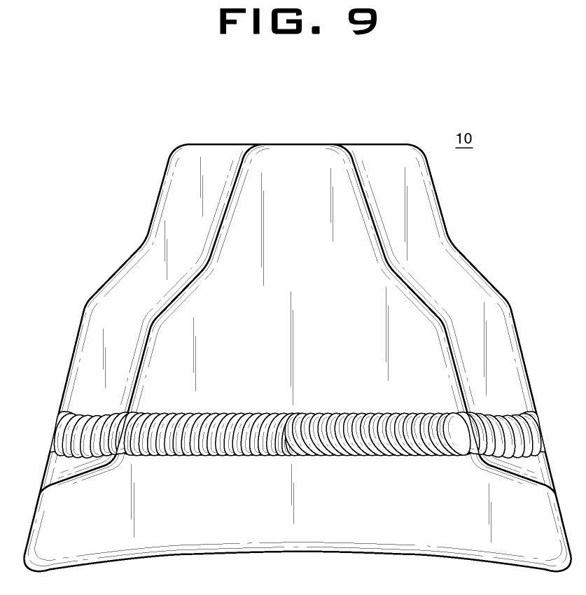

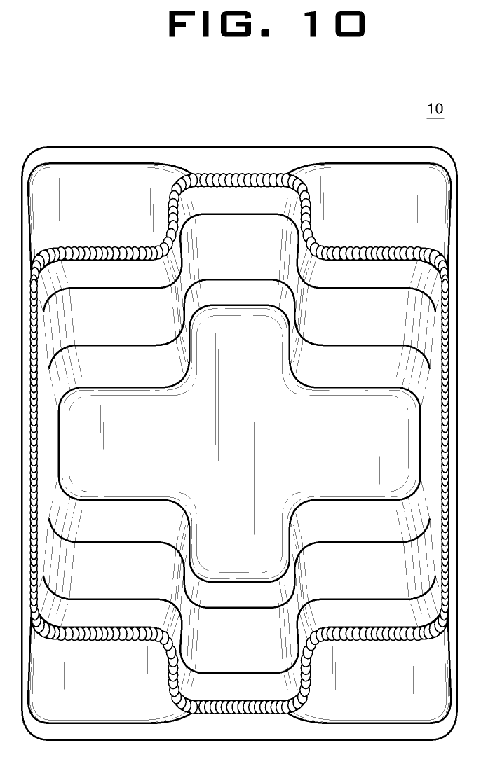

The foregoing invention finds utility in various industrial applications, such as the construction and mining industry in providing an improved soil compacting tip for a soil compactor, and in the landfill and waste removal industries in providing an improved landfill compacting tip for landfill compactors. An exemplary landfill compactor wheel 20 having several compactor tip assemblies 10 attached to the wheel wrapper 21 is illustrated in FIG. 6.

We claim:

1. A compactor tip assembly comprising:
a tip having first ground engaging surfaces, the tip being formed of a first metal;
a base having second ground engaging surfaces, the base being formed of a second metal dissimilar to the first metal; and
the tip and the base are joined together through a weld joint.

2. A compactor tip assembly according to claim 1, further comprising a hollow pocket formed at least in the base.

3. A compactor tip assembly according to claim 2 wherein the hollow pocket comprises a through passageway formed in the base, and a depression formed in the tip.

4. A compactor tip assembly according to claim 3 wherein:
the base comprises a wheel engaging surface and a tip engaging surface formed generally opposite the wheel engaging surface;
second ground engaging surfaces separate the wheel engaging surface from the tip engaging surface; and
the through passageway is formed between and intersects each of the wheel engaging surface and the tip engaging surface.

5. A compactor tip assembly according to claim 4 wherein:
the tip comprises a base engaging surface which faces the tip engaging surface of the base; and
the depression in the tip intersects the base engaging surface.

6. A compactor tip assembly according to claim 5 wherein:
the depression intersects the base engaging surface to define an intersection boundary;
the through passageway intersects the tip engaging surface to define an intersection boundary; and
the intersection boundary of the tip and the intersection boundary of the base are substantially the same size and shape.

7. A compactor tip assembly comprising:
a tip having first ground engaging surfaces;
a base having second ground engaging surfaces;
the tip and the base are joined together through a weld joint; and
a hollow pocket formed at least in the base.

8. A compactor tip assembly according to claim 7 wherein the hollow pocket comprises a through passageway formed in the base, and an depression formed in the tip.

9. A compactor tip assembly according to claim 8 wherein:
the base comprises a wheel engaging surface and a tip engaging surface formed generally opposite the wheel engaging surface;
second ground engaging surfaces separate the wheel engaging surface from the tip engaging surface; and
the through passageway is formed between and intersects each of the wheel engaging surface and the tip engaging surface.

10. A compactor tip assembly according to claim 9 wherein:
the tip comprises a base engaging surface which faces the tip engaging surface of the base;
the depression in the tip intersects the base engaging surface to define an intersection boundary;
the through passageway intersects the tip engaging surface to define an intersection boundary; and
the intersection boundary of the tip and the intersection boundary of the base are substantially the same size and shape.

11. A compactor tip assembly according to claim 7 wherein the tip is formed from a first metal, and the base is formed from a second metal dissimilar to the first metal.

12. A compactor tip assembly according to claim 11 wherein the tip is formed from a medium or high carbon steel, and the base is formed from a low carbon steel.

13. A compactor tip assembly according to claim 12 wherein the tip is formed from a low alloy steel.

14. A method of manufacturing a compactor tip assembly comprising:
forming a tip having first ground engaging surfaces from a medium or high carbon steel;
forming a base having second ground engaging surfaces from a low carbon steel; and
preheating at least the tip, and welding the preheated tip to the base to form a compactor tip assembly.

15. A method of manufacturing a compactor tip assembly according to claim 14 wherein preheating at least the tip further comprises preheating both the tip and the base to a temperature between approximately 150° C. and 230° C.

16. A method of manufacturing a compactor tip assembly according to claim 14 further comprising forming the tip from a low alloy steel.

17. A method of manufacturing a compactor tip assembly according to claim 14 further comprising forming the tip and the base through a forging process.
